(19) United States
(12) Patent Application Publication
(10) Pub. No.: US 2016/0045075 A1
(43) Pub. Date: Feb. 18, 2016

(54) Dual Drive Adapter for Kitchen Appliance

(71) Applicant: Hamilton Beach Brands, Inc., Glen Allen, VA (US)

(72) Inventors: Kevin Leppert, Lanexa, VA (US); Benjamin H. Branson, Mechanicsville, VA (US)

(21) Appl. No.: 14/825,513

(22) Filed: Aug. 13, 2015

Related U.S. Application Data
(60) Provisional application No. 62/037,623, filed on Aug. 15, 2014.

(51) Int. Cl. A47J 43/08; F16H 7/08; F16H 7/02

(52) U.S. Cl. CPC A47J 43/085; F16H 7/02; F16H 7/08; F16H 2007/0891; F16H 2007/088; F16H 2007/0865; F16H 2007/0842

(57) ABSTRACT

An adapter for a blender is provided. The blender includes a base having a housing enclosing a motor. The adapter includes a first drive shaft having a clutch hub configured to be drivingly coupled to a first set of blending blades and a first pulley, a second drive shaft having a spline configured to be drivingly coupled to a second set of blending blades and a second pulley configured to be operatively coupled to the motor, and a belt which engages the first and second pulleys. The clutch hub and the spline are positioned outside of the housing. Operation of the motor causes rotation of the second pulley, the second drive shaft and the second set of blending blades. The rotation of the second pulley causes movement of the belt which, in turn, causes rotation of the first pulley, the first drive shaft and the first set of blending blades.

### CROSS-REFERENCE TO RELATED APPLICATIONS

This application claims priority to U.S. Provisional Patent Application No. 62/037,623, filed on Aug. 15, 2014, entitled “Dual Drive Adapter for Kitchen Appliance,” the entire contents of which are incorporated by reference herein.

### BACKGROUND OF THE DISCLOSURE

The present disclosure relates generally to a kitchen appliance configured to mix, process or blend foodstuff and, more particularly, to a blender or other such kitchen appliance that includes a relatively large jar for containing foodstuff and at least a relatively smaller container for containing foodstuff, wherein the jar and the at least one relatively smaller container are separately removably mountable to the base for blending and the blending of foodstuff contained therein may be accomplished by only a single motor.

Blenders are a relatively common household or kitchen appliance that are used to blend foodstuff, typically drinks or other foodstuff that is blended into a semi-fluid state. A typical blender includes a base enclosing a motor, a jar removably mounted to the base for containing the foodstuff and a lid to enclose the foodstuff within the jar. More recently, it has become popular to provide jars of various size and shape to accommodate a users needs in blending a variety of foodstuff. For example, certain blender bases, as seen in the food services industry, accommodate relatively large jars to blend large amounts of foodstuff at one time. Other types of blenders bases accommodate relatively small or portable containers or cups, such as a travel mug, to blend smaller amounts of foodstuff for individual or portable use.

However, such conventional blenders require two separate motors, one of which operates the blending blades of the jar and the other of which operates the blending blades of the small container. A resulting drawback is increased manufacturing costs and complexity.

Therefore, it would be desirable to provide an adapter that allow for simultaneous blending within a relatively large jar and/or a relatively small container by operation of just a single motor.

### BRIEF SUMMARY

In one embodiment, the present disclosure is directed to an adapter for a blender including a base having a housing which encloses a motor. The housing has a top wall and an opposing bottom wall. The adapter includes a first drive shaft having a first clutch hub configured to be drivingly coupled to a first set of blending blades and a first pulley, the first clutch hub being positioned outside of the housing of the base of the blender; a second drive shaft having a first spline configured to be drivingly coupled to a second set of blending blades and a second pulley configured to be operatively coupled to the motor, the first spline being positioned outside of the housing of the base of the blender; and a belt which engages the first and second pulleys. The adapter is configured to be positioned proximate the top wall of the housing of the base of the blender. Operation of the motor causes rotation of the second pulley, the second drive shaft and the second set of blending blades. The rotation of the second pulley causes movement of the belt and the rotation of the belt, in turn, causes rotation of the first pulley, the first drive shaft and the first set of blending blades.

Another embodiment of the present disclosure is directed to a blender including a base having a housing, a motor enclosed within the housing and having a drive shaft with a motor clutch mounted on a distal end thereof, and first, second and third containers. Each of the first, second and third containers is provided with a first, second and third set of blending blades, respectively. The third container is of a different size than the first and second containers. The blender further includes an adapter having a first drive shaft drivingly coupled to the first set of blending blades, a second drive shaft drivingly coupled to the second set of blending blades, and a third drive shaft drivingly coupled to the third set of blending blades and the motor. The first, second and third drive shafts of the adapter are drivingly coupled to each other. Operation of the motor causes simultaneous rotation of the first, second and third drive shafts and the first, second and third sets of blending blades.

### BRIEF DESCRIPTION OF THE SEVERAL VIEWS OF THE DRAWINGS

The foregoing summary, as well as the following detailed description of the disclosure, will be better understood when read in conjunction with the appended drawings. For the purpose of illustrating the disclosure, there are shown in the drawings embodiments which are presently preferred. It should be understood, however, that the disclosure is not limited to the precise arrangements and instrumentalities shown. In the drawings:

FIG. 1 is a perspective view of a kitchen appliance according to an embodiment of the present disclosure, wherein the kitchen appliance is shown in a first operating configuration;

FIG. 2 is another perspective view of the kitchen appliance shown in FIG. 1, wherein the kitchen appliance is shown in a second operating configuration;

FIG. 3 is a top perspective partially broken away view of an adapter positioned on top of a base of the kitchen appliance shown in FIG. 1, wherein various components of the kitchen appliance are omitted for clarity;

FIG. 4 is a bottom perspective view of the adapter shown in FIG. 3;

FIG. 5 is a side perspective view of the blending collars and the adapter of the kitchen appliance shown in FIG. 1, wherein various components of the kitchen appliance are omitted for clarity;

FIG. 6 is a front elevation view of the kitchen appliance shown in FIG. 1, wherein various components are omitted and the first and second containers are shown in phantom for clarity; and

FIG. 7 is a rear elevation view of the kitchen appliance shown in FIG. 1, wherein various components are omitted and the blending jar is shown in phantom for clarity.

### DETAILED DESCRIPTION OF THE DISCLOSURE

Certain terminology is used in the following description for convenience only and is not limiting. The words “lower,” “bottom,” “upper” and “top” designate directions in the drawings to which reference is made. The words “inwardly,” “outwardly,” “forward,” “rearward,” “upwardly” and “downwardly” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

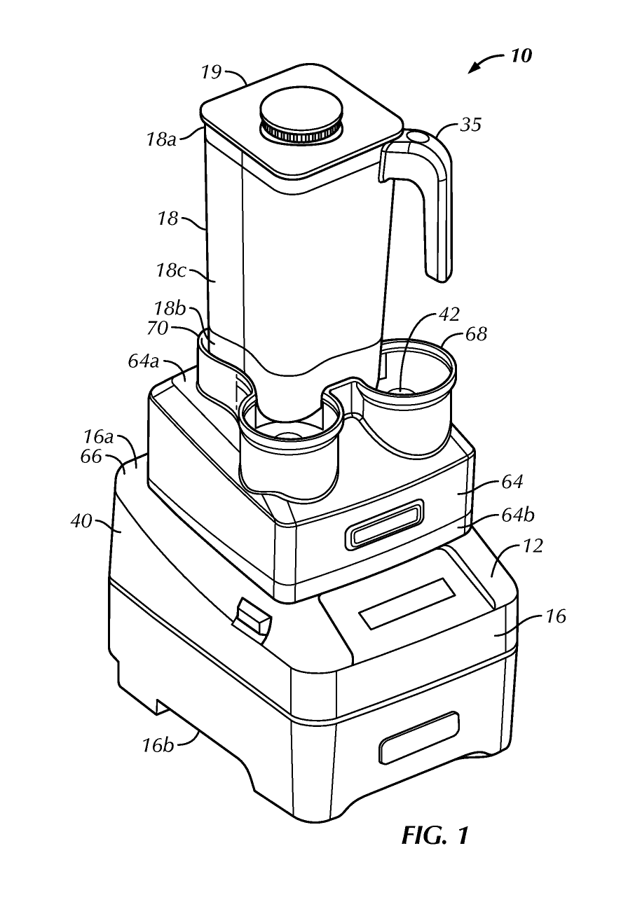

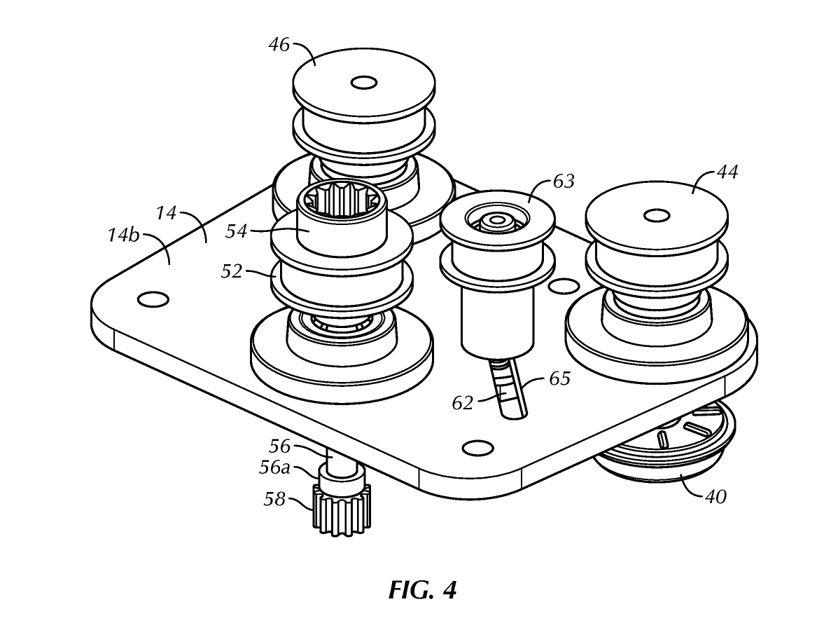

Referring to the drawings in detail, wherein like numerals are used to indicate like elements throughout, there is shown in FIGS. 1-5 a preferred embodiment of a kitchen appliance, generally designated 10, configured to mix or blend foodstuff (not shown). The kitchen appliance 10 is preferably in the form of a conventional kitchen blender, but could be other products such as a food processor, an ice cream machine or a smoothie machine without departing from the spirit and scope of the present disclosure.

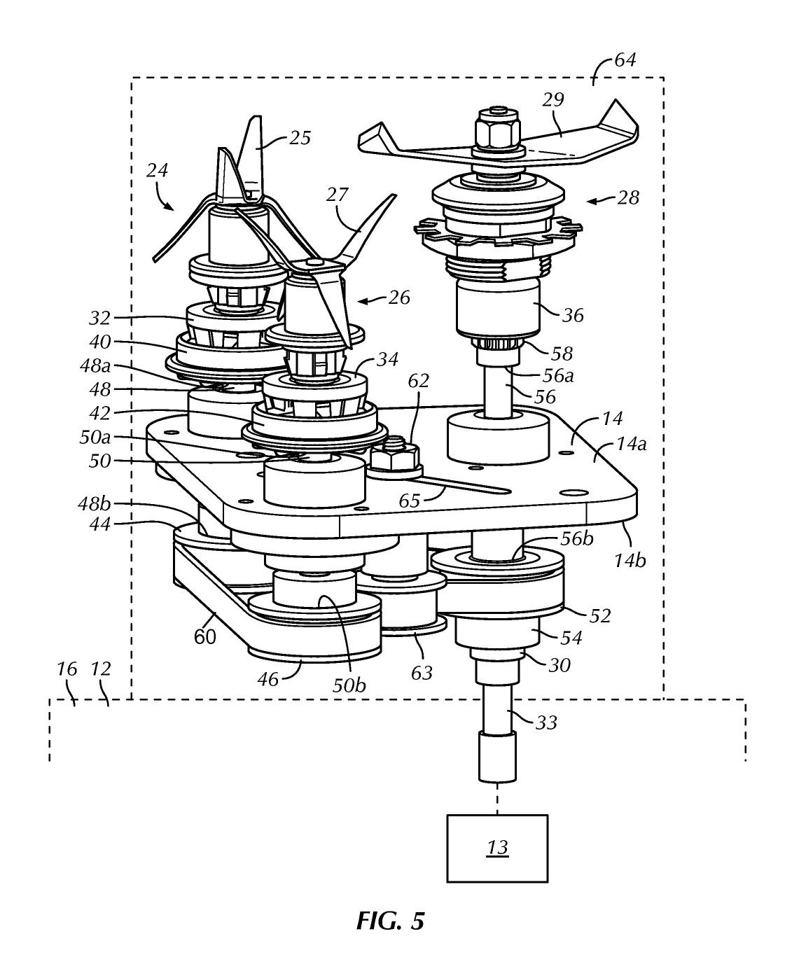

Referring to FIGS. 1-5, the kitchen appliance 10 preferably includes a base 12 enclosing a motor 13 (shown schematically in FIG. 5). The base 12 includes a housing 16 having a top wall 16a and an opposing bottom wall 16b. The base housing 16 is preferably formed of a high strength, lightweight material, such as a polymeric material. The bottom wall 16b of the base 12 preferably rests directly on a support surface (not shown), such as a table top or countertop, when the kitchen appliance 10 is in use. The bottom wall 16b may include a series of feet (not shown) comprised of an elastomeric or other non-skid, shock absorbing material for providing stability to the kitchen appliance 10.

The motor 13 is preferably at least generally surrounded by the base housing 16 and positioned beneath the top wall 16a thereof. Referring to FIG. 5, the motor 13 preferably includes a drive shaft 33 with a motor clutch 30 mounted on a distal end thereof. Preferably, the motor 13 is operable by a control button (not shown). The control button, which may be any type of conventional control knob as known to those skilled in the art, allows the user to control the operation and speed of the motor 13. The base 12 may include vent openings (not shown) and/or a fan (not shown) to expel and/or dissipate heat generated by the motor 13. The motor 13 is preferably a one speed universal motor, but the present disclosure is not so limited, as the motor 13 may have multiple, distinct speeds that are selected by a user. Power may be supplied to the motor 13 by a conventional wall outlet (not shown) through a power cord (not shown), or by one or more conventional batteries (none shown).

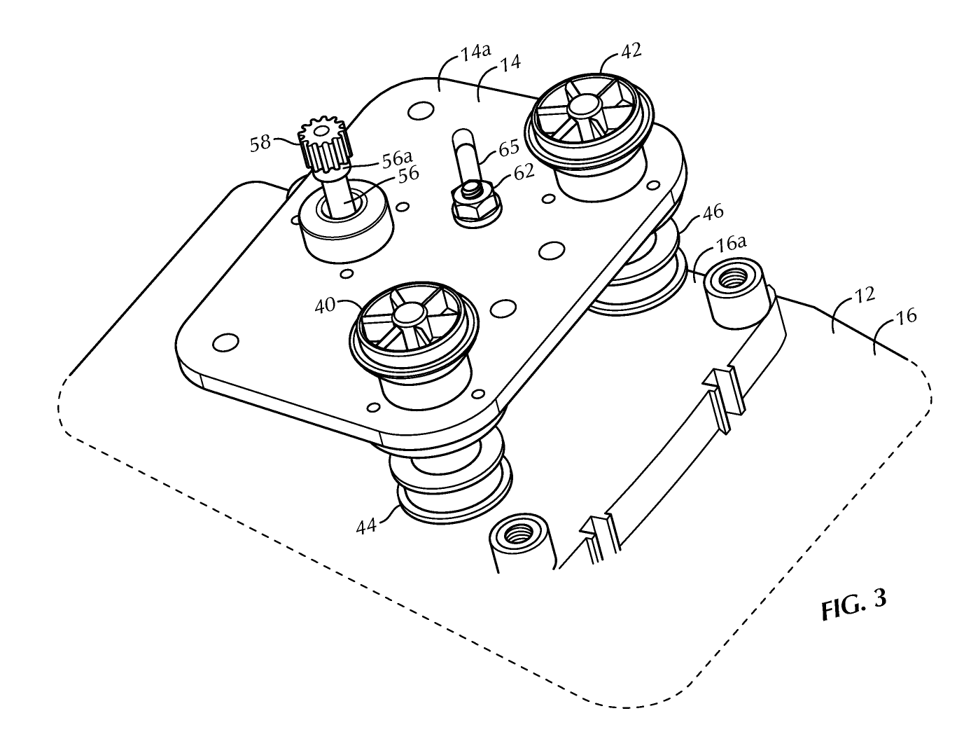

Referring to FIGS. 3-5, the kitchen appliance 10 further includes an adapter 14 which enables the motor 13 to drive a variety of differently sized jars or containers, as described in detail below. The adapter 14 is preferably in the form of a generally planar or flat metal plate having a top wall 14a and an opposing bottom wall 14b.

Referring to FIG. 5, the adapter 14 preferably includes first, second and third drive shafts 48, 50, 56 which extend through the thickness of the adapter 14 and are each spaced apart from each other. A first end 48a of the first drive shaft 48 includes a first clutch hub 40 fixedly attached thereto and an opposing second end 48b includes a first pulley 44 fixedly attached thereto (see FIGS. 3-5). Similarly, a first end 50a of the second drive shaft 50 includes a second clutch hub 42 fixedly attached thereto and an opposing second end 50b includes a second pulley 46 fixedly attached thereto (see FIGS. 3-5). A first end 56a of the third drive shaft 56 includes a first spline 58 fixedly attached thereto and an opposing second end 56b includes a third pulley 52 fixedly attached thereto (see FIGS. 3-5). The first and second clutch hubs 40, 42 and the first spline 58 are preferably provided proximate the top wall 14a of the adapter 14 and the first, second and third pulleys 44, 46, 52 are preferably provided proximate the bottom wall 14b of the adapter 14. A belt 60, and more particularly an endless belt 60, engages the first, second and third pulleys 44, 46, 52, as shown in FIG. 5, such that all three pulleys 44, 46, 52 will simultaneously rotate.

Referring to FIGS. 3-5, the adapter 14 also includes a tensioner assembly including a tensioning nut 62, a slot 65 along which the tensioning nut 62 may travel, and a fourth pulley 63 in contact with the belt 60. The fourth pulley B includes a threaded shaft 62a slidably extending through the slot 65 for threadably receiving the nut 62. The tensioner assembly can be used to adjust the amount of tension force applied to the belt 60. More particularly, the tensioning nut 62 may be loosened on the shaft 62a, moved to any one of various positions along the slot 65, and then tightened to remain in position in the slot 65, in order to increase or decrease the amount of tension applied to the belt 60. The tensioning nut 62 may be manually operated or automatically operated (e.g., as a spring-loaded tensioner) to keep the desired tension on the belt 60.

In a direction extending away from the third drive shaft 56 and toward the motor 13, the third pulley 52 preferably includes a third clutch hub 54 configured to engage the motor clutch 30, as shown in FIG. 5. As such, the first, second and third pulleys 44, 46, 52 are each operatively connected to the motor 13. More particularly, operation of the motor 13 causes (via the engagement between the motor clutch 30 and the third clutch hub 54) rotation of the third pulley 52 and the third drive shaft 56. The rotation of the third pulley 52 causes movement of the belt 60 which, in turn, causes rotation of the first and second pulleys 44, 46 and the associated first and second drive shafts 48, 50.

In one embodiment, as shown in FIG. 5, the adapter 14 is an optional accessory for the kitchen appliance 10 and is thus a separate component from the kitchen appliance 10. In such an embodiment, the motor drive shaft 33 and the motor clutch 30 preferably extend out of the base 12 and the adapter 14 is positioned on the top wall 16a of the base housing 16, such that the motor clutch 30 is received within the third clutch hub 54 of the adapter 14. Preferably, the adapter is removably attached, fixed and/or locked to the base 12 proximate the top wall 16a of the base housing 16.

In this embodiment, as shown in FIGS. 1-2 and 5, an adapter housing 64 is preferably provided to at least generally surround and enclose the adapter 14. The adapter housing 64 has a top wall 64a and an opposing bottom wall 64b configured to directly engage the top wall 16a of the base housing 16. The adapter housing 64 is preferably formed of a high strength, lightweight insulating material, such as a polymeric material.

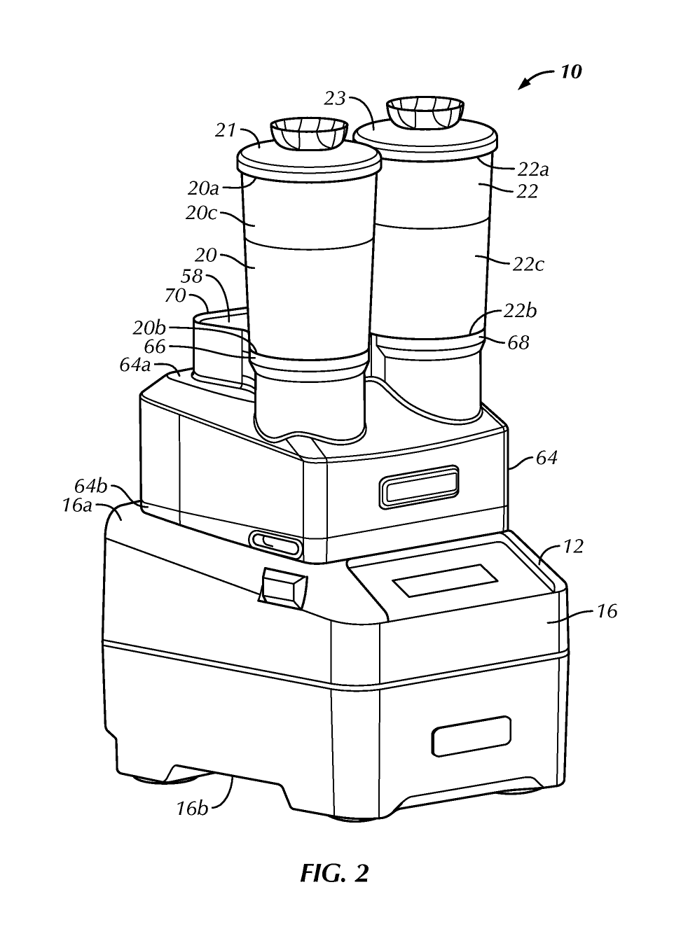

As shown in FIGS. 1-2, the top wall 64a of the adapter housing 64 preferably includes first and second recessed areas 66, 68 of relatively small dimensions and a third recessed area 70 of dimensions larger than those of the first and second recesses 66, 68. The third recessed area 70 is preferably sized and shaped to receive and operate a relatively large container or jar 18 and the first and second recessed areas 66, 68 are each preferably sized and shaped to receive and operate first and second relatively small containers 20, 22, respectively. The first and second relatively small containers 20, 22 allow a user to blend smaller amounts of foodstuff than those typically used with the relatively large jar 18. For the sake of brevity, the relatively large jar 18 will be referred hereinafter as a “jar” and the relatively smaller jars 20, 22 will be referred to hereinafter as “containers.”

It will be understood by those skilled in the art that while the first and second containers 20, 22 are of generally equal dimensions and the corresponding first and second recessed portions 66, 68 are of generally equal dimensions, these dimensions may vary such that the first container 20 and the first recessed portion 66 are larger than the second container 22 and the second recessed portion 68, and vice versa. It will also be understood by those skilled in the art that the kitchen appliance 10 may accommodate more than two jars or containers without departing from the spirit and scope of the present disclosure. In addition, the adapter 14 could be arranged to drive two or more equally sized containers or jars.

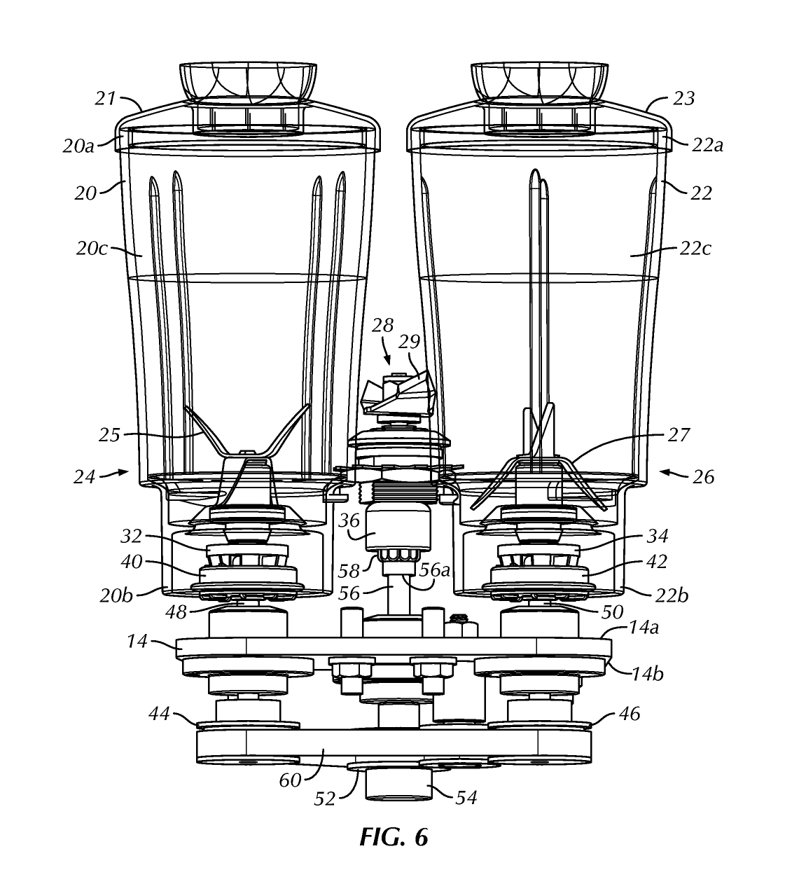

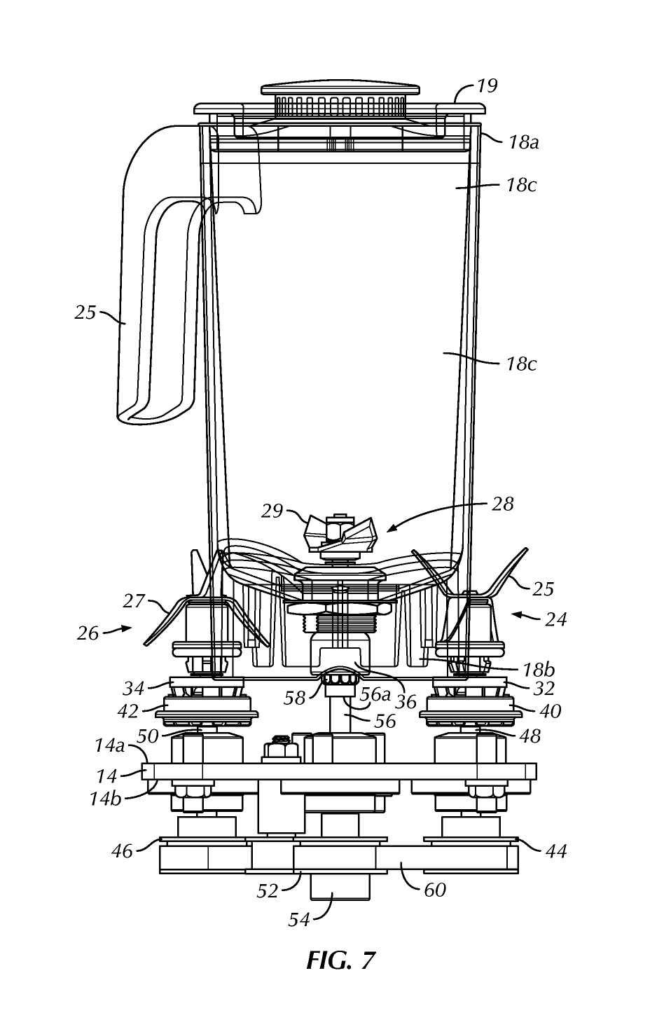

The jar 18 and the first and second containers 20, 22 are each configured to be independently and removably positioned on the adapter housing 64. More particularly, in a first operating configuration, as shown in FIGS. 1 and 7, only the jar 18 is positioned in the third recessed area 70. In a second operating configuration, as shown in FIGS. 2 and 6, the first container 20 and/or the second container 22 is positioned in the first recessed area 66 and/or the second recessed area 68, respectively. In a third operating configuration (not shown), the jar 18 is positioned in the third recessed area 70 and the first and second containers 20, 22 are positioned in the respective first and second recessed areas 66, 68.

The jar 18 is preferably in the form of a conventional blender jar, but could alternatively be in the form of a pitcher, bucket, barrel or any other container used to hold liquid or blended foodstuff. Each of the first and second containers 20, 22 is preferably in the form of a conventional travel mug or travel cup, but could be other products such as a portable coffee cup, a water bottle, a sports bottle or any other container used to hold liquid or blended foodstuff

The jar 18 and the first and second containers 20, 22 each has a respective first open end or top 18a, 20a, 22a; an opposing second end or bottom 18b, 20b, 22b; and a sidewall 18c, 20c, 22c extending therebetween that generally surrounds a cavity for holding foodstuff (not shown) to be blended, processed and/or chopped. The jar 18 and the containers 20, 22 also preferably include respective lids 19, 21, 23 removably mounted to the first open ends 18a, 20a, 22a thereof to enclose the foodstuff therein. As show in FIGS. 1 and 7, the jar 18 includes a handle 35 which extends outwardly therefrom. It will be understood that the containers 20, 22 may also include a handle.

The jar 18 preferably has a generally circular or square cross-sectional shape and the containers 20, 22 preferably have generally circular cross-sectional shapes, but it will be understood by those skilled in the art that the jar 18 and the containers 20, 22 may have any appropriate shape for blending foodstuff. The third recessed area 70 preferably has a shape that complements that of the jar 18, while the first and second recessed areas 66, 68 have shapes that complement that of the first and second containers 20, 22, respectively.

The jar 18 and the containers 20, 22 are preferably formed of a high strength, lightweight insulating material, such as a polymeric material, preferably Styrene Acrylonitrile (SAN), to allow the user to view the blended food or beverage. However, it will be understood by those skilled in the art that the jar 18 and the containers 20, 22 may be formed of virtually any material, such as a metallic material or glass, without departing from the spirit and scope of the present disclosure.

Referring to FIGS. 5-7, a first blending collar 24 is removably mounted within and encloses the bottom 20b of the first container 20, a second blending collar 26 is removably mounted within and encloses the bottom 22b of the second container 22, and a third blending collar 28 is removably mounted within and encloses the bottom 18b of the jar 18. The blending collars 24, 26, 28 maybe removably mounted to the containers 20, 22 and the jar 18 in virtually any manner, such as by threaded engagement, adhesion, magnetism or by friction-fitting, without departing from the spirit and scope of the present disclosure.

The first, second and third blending collars 24, 26, 28 include respective first, second and third sets of blending blades 25, 27, 29 extending in a direction away from the motor. In an assembled position, the first and second sets of blending blades 25, 27 extend into respective interiors of the first and second containers 20, 22, and the third set of blending blades 29 extends into the interior of the jar 18.

In another preferred embodiment (not shown), the adapter 14 is an integral component of the kitchen appliance 10 and is generally surrounded by the base housing 16 and positioned beneath the top wall 16a thereof together with the motor 13, the motor drive shaft 33 and the motor clutch 30. In such an embodiment, the adapter housing 64 and the base 12 are essentially integrally formed to provide the base housing 16 and the first, second and third recessed areas 66, 68, 70 are formed in the top wall 16a of the base housing 16.

The adapter 14 enables the relatively large jar 18 and the relatively small containers 20, 22 to be operatively connected to and operated by the single motor 13 of the kitchen appliance 10, as follows. Preferably, the first clutch hub 40 of the first drive shaft 48 is located within the first recessed area 66 and a complementary clutch 32 extends from a bottom surface of the first blending collar 24 to releasably engage the first clutch hub 40 of the first recessed area 66, as shown in FIGS. 1 and 5-6. Preferably, the second clutch hub 42 of the second drive shaft 50 is located within the second recessed area 68 and a complementary clutch 34 extends from a bottom surface of the second blending collar 26 to releaseably engage the second clutch hub 42 of the second recessed area 68, as shown in FIGS. 1 and 5-6. The first spline 58 of the third drive shaft 56 is preferably located within the third recessed area 70 and a bottom surface of the third blending collar 28 of the jar 18 includes a complementary spline hub 36 configured to releaseably engage the first spline 58 of the third recessed area 70, as shown in FIGS. 2, 5 and 7.

As such, when the first and second containers 20, 22 and the jar 18 and the associated first, second and third blending collars 24, 26, 28 are properly mounted onto the base 12, as shown in FIGS. 1-2 and 5-7, the adapter 14 allows for the first, second and third sets of blending blades 25, 27, 29 to be operatively connected to the motor 13 utilizing a plurality of clutch mechanisms. More particularly, the first, second and third drive shafts 48, 50, 56 of the adapter 14 are operatively coupled with the motor 13 and drivingly coupled to the first set of blending blades first, second and third sets of blending blades 25, 27, 29, such that the first, second and third sets of blending blades 25, 27, 29 are operatively connected to the motor 13.

Preferably, the clutches 32, 34 and corresponding clutch hubs 40, 42 are made of a polymeric material, such as rubber or plastic. Preferably, the spline 58 and corresponding spline hub 36 are made of a metal. However, it will be understood by those skilled in the art that the clutches 32, 34 and corresponding clutch hubs 40, 42 and the spline 58 and corresponding spline hub 36 of the various connector mechanisms may be made of any appropriate materials, such as a metal, a polymeric material (e.g., rubber, plastic and the like), or a combination of such materials. It will be understood by those skilled in the art that the positions of the complementary clutches/clutch hubs and splines/spline hubs of the various connector mechanisms may be reversed. It will also be understood by those skilled in the art that any appropriate connector mechanism may be used in place of one or more of the various clutch and/or spline mechanisms described herein.

More particularly, in operation, the user places the base 12 onto the support surface, such as the countertop or tabletop, so that the base 12 support is flush with the support surface to provide stability to the kitchen appliance 10. Next, the user operatively connects the power cord of the base 12 to an electrical outlet in a conventional manner. At this point, the user has the option of using the jar 18 or one or both of the first and second containers 20, 22.

If the user desires that the blending operation requires the relatively large jar 18, the user mounts the third blending collar 28 into the bottom 18b of the jar 18 to close the bottom 18b (or the third blending collar 28 may already be mounted to or may be integrally formed with the bottom 18b of the jar 18). Then, the jar 18 can be mounted within the third recessed area 70 of the adapter housing 64 (if the adapter 14 is only an optional attachment accessory) or the appropriate recessed area of the base 12 to operatively connect the complementary spline hub 36 with the first spline 58.

Alternatively, if the user determines that a smaller amount of foodstuff will be blended, the user may choose to blend foodstuff within either or both of the containers 20, 22. In this configuration, the user will mount the first and/or second blending collars 24, 26 to the bottoms 20b, 22b of the first and/or second containers 20, 22, respectively (or the first and/or second blending collars 24, 26 may already be mounted to or integrally formed with the bottoms 20b, 22b). Then, the first and/or second containers 20, 22 can be mounted within the first and/or second recessed areas 66, 68, respectively of the adapter housing 64 (if the adapter 14 is only an optional attachment accessory) or the appropriate recessed areas of the base 12 to operatively connect the first clutch hub 40 with the complementary clutch 32 and/or to operatively connect the second clutch hub 42 with the complementary clutch 34.

Next, the user actuates the appropriate control button to commence operation of the motor. Operation of the motor 13 causes rotation of the motor drive shaft 33, the engaged motor clutch 30 and third clutch hub 54, the third pulley 52, the third drive shaft 56 and the engaged spline hub 36 and first spline 58, all of which, in turn, cause rotation of the third set of blending blades 29 (see FIG. 5). Further, the endless belt 60 engaged with the rotating third pulley 52 will, in turn, cause rotation of the first and second pulleys 44, 46. Rotation of the first and second pulleys 44, 46 causes rotation of the associated drive shafts 48, 50, the engaged clutch hub 40 and complementary clutch 32 and/or the engaged clutch hub 42 and complementary clutch 34, which, in turn, cause rotation of the first and/or second sets of blending blades 25, 27. As such, the adapter 14 allows for the first, second and third sets of blending blades 25, 27, 29 to be operatively connected to and operated by the single motor 13 of the kitchen appliance 10.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the appended claims.

We claim:

1. An adapter for a blender comprising a base having a housing which encloses a motor, the housing having a top wall and an opposing bottom wall, the adapter comprising:
a first drive shaft having a first clutch hub configured to be drivingly coupled to a first set of blending blades and a first pulley, the first clutch hub being positioned outside of the housing of the base of the blender;
a second drive shaft having a first spline configured to be drivingly coupled to a second set of blending blades and a second pulley configured to be operatively coupled to the motor, the first spline being positioned outside of the housing of the base of the blender; and
a belt which engages the first and second pulleys,
wherein the adapter is configured to be positioned proximate the top wall of the housing of the base of the blender,
wherein operation of the motor causes rotation of the second pulley, the second drive shaft and the second set of blending blades,
wherein the rotation of the second pulley causes movement of the belt, and
wherein the rotation of the belt causes rotation of the first pulley, the first drive shaft and the first set of blending blades.

2. The adapter according to claim 1, further comprising a third drive shaft having a second clutch hub configured to be drivingly coupled to a third set of blending blades and a third pulley, wherein the belt engages the first, second and third pulleys.

3. The adapter according to claim 2, wherein the rotation of the belt causes rotation of the third pulley, the third drive shaft and the third set of blending blades.

4. The adapter according to claim 1, further comprising a slot formed in a body of the adapter, a tensioning nut configured to travel along the slot, and a shaft extending through the slot, the shaft having a first end secured to the tensioning nut and a second end having a fourth pulley in contact with the belt, the tensioning nut and the shaft being configured to be move to different positions along the slot to adjust a tension force applied to the belt.

5. The adapter according to claim 1, wherein the second pulley includes a clutch hub configured to engage a motor clutch of the motor.

6. The adapter according to claim 1, wherein the adapter is removably attached to the blender.

7. The adapter according to claim 6, wherein the adapter is configured to be positioned above the top wall of the base of the housing of the blender.

8. The adapter according to claim 7, wherein the adapter is enclosed by an adapter housing positioned on the top wall of the base of the housing of the blender.

9. A blender comprising:
a base having a housing;
a motor enclosed within the housing, the motor having a drive shaft with a motor clutch mounted on a distal end thereof;
a first container provided with a first set of blending blades, a second container provided with a second set of blending blades, and a third container provided with a third set of blending blades, the third container being of a different size than the first and second containers;
an adapter having a first drive shaft drivingly coupled to the first set of blending blades, a second drive shaft drivingly coupled to the second set of blending blades, and a third drive shaft drivingly coupled to the third set of blending blades and the motor,
wherein the first, second and third drive shafts of the adapter are drivingly coupled to each other, and
wherein operation of the motor causes simultaneous rotation of the first, second and third drive shafts and the first, second and third sets of blending blades.

10. The blender according to claim 9,
wherein the first drive shaft includes a first end having a first clutch hub drivingly coupled to the first set of blending blades and an opposing second end having a first pulley,
wherein the second drive shaft includes a first end having a second clutch hub drivingly coupled to the second set of blending blades and an opposing second end having a second pulley, and
wherein the third drive shaft includes a first end having a first spline drivingly coupled to the third set of blending blades and an opposing second end having a third pulley.

11. The blender according to claim 10, further comprising an endless belt which engages the first, second and third pulleys, such that all three pulleys simultaneously rotate upon operation of the motor.

12. The blender according to claim 11, wherein the adapter includes a slot formed in the adapter, a tensioning nut configured to travel along the slot, and a shaft extending through the slot, the shaft having a first end secured to the tensioning nut and a second end having a fourth pulley in contact with the belt, the tensioning nut and the shaft being configured to be move to different positions along the slot to adjust a tension force applied to the belt.

13. The blender according to claim 10, wherein the third pulley includes a clutch hub configured to drivingly engage the motor clutch.

14. The blender according to claim 9, wherein the adapter is removably attached to the base.

15. The blender according to claim 9, wherein the adapter is fixedly attached to the base.

16. The blender according to claim 9, further comprising an adapter housing provided to at least generally surround and enclose the adapter.

17. The blender according to claim 16, wherein the adapter housing includes a first recessed area sized and shaped to receive the first container, a second recessed area sized and shaped to receive the second container, and a third recessed area sized and shaped to receive the third container.
